(19) United States
(12) Patent Application Publication
(10) Pub. No.: US 2011/0314515 A1
(43) Pub. Date: Dec. 22, 2011

(54) INTEGRATED PHYSICAL AND LOGICAL SECURITY MANAGEMENT VIA A PORTABLE DEVICE

(76) Inventors: Melanie S. Hernoud, Dacono, CO (US); Elizabeth J. Pierce, Dacono, CO (US); David Duran Dunn, Dacono, CO (US)

(21) Appl. No.: 13/143,431

(22) PCT Filed: Jan. 6, 2010
(86) PCT No.: PCT/US10/20244

§ 371 Date: Aug. 19, 2011

Related U.S. Application Data
(60) Provisional application No. 61/142,792, filed on Jan. 6, 2009.

(51) Int. Cl. H04L 9/32

(52) U.S. Cl. 726/2

(57) ABSTRACT

Integrated physical and logical security management is extended to a mobile device, such as a portable wireless device or radio The Mobile-IMPACT solution extends the reach of authonzed users to hand-held devices for momtoπng, managing and/or controlling of IT/network and physical security Allowing authorized users to view and control access events while not in their office and logged into their console, mobility within and outside of a facility or campus organization no longer requires a laptop computer With new handheld technologies more widely accessiable and dropping in mice while still gaining additional functionality, a chief security officer and their security staff can now monitor access to their building/doors/control zones, look-up user and card information, trigger queries/reports, set new alarm conditions and monitor sensors or a perimeter from a handheld device anywhere in the world using an electronic communication medium.

### RELATED APPLICATION DATA

This application claims the benefit of and priority under 35 U.S.C. §119(e) to U.S. Patent Application No. 61/142,792, filed Jan. 6, 2009, entitled “Integrated Physical and Logical Security Management Through A Portable Wireless Device,” and is related to U.S. Application Ser. No. 11/740,063, (and corresponding PCT Application PCT/US07/67404) entitled “Logical and Physical Security” filed, Apr. 25, 2007, all of which are incorporated herein by reference in their entirety.

### FIELD

An exemplary aspect relates to one or more of control, management and access to one or more of logical and physical security. More specifically, exemplary aspects relate to mobile control, management and access to one or more of logical and physical security. Another exemplary aspect relates to a radio configured to control, management and access to one or more of logical and physical security.

### BACKGROUND

Related U.S. application Ser. No. 11/740,063 is at least directed toward integrated logical and physical security. More specifically, FIG. 1 in the related application illustrates an exemplary security system 1. The security system includes an IT/Network and Physical Security Management System 100 (CRITSEC), an Incident Management Perimeter Access Control and Tracking module 200 (IMPACT) and a credential issuance system 300. The IT/Network and Physical Security management System 100 can be connected, via one or more of network 10 and links 5, to one or more additional IT/Network and Physical Security Management Systems as well as an identity proofing module 110, one or more sensors 120, a unified credential 130, one or more access control readers 140 (which can govern physical as well as network/computer access), one or more cameras and/or video cameras or feeds 150, existing enterprise IT security system(s) 160, existing enterprise security systems 170, such as building access systems and alarm systems 180 and associated annunciators 185 and devices.

The system is in general directed toward security and security management. An exemplary aspect relates to physical security management and information technology/network security management. Additional aspects relate to a credential issuance and integrity checking systems as well as associated readers/writers and printers of the credential certificate and electronic personalization. Still further aspects relate to obtaining, assembling and analyzing one or more of data, video information, image information, biometric information, sensor information, alarm information, perimeter information, terrorist information, critical infrastructure information, profile information, and/or other types of information to provide a comprehensive platform for all aspects of security management. Still further aspects of the invention relate to providing a scalable toolkit that allows complete management, integration, interoperability and centralized control and monitoring of all aspects of security including personnel credentialing, personnel management, personnel tracking, emergency management, executive protection, task management, equipment management, personnel tracking, security system integration, computer/network access, and security information exchange.

### SUMMARY

Expanding on the above concepts, an exemplary aspect of the invention relates to an extension of integrated physical and logical security management to a mobile device, such as a portable wireless device or radio. The Mobile-IMPACT solution extends the reach of authorized users to handheld devices for monitoring, managing and/or controlling of IT/network and physical security. Allowing authorized users to view and control access events while not in their office and logged into their console, mobility within and outside of a facility or campus organization no longer requires a laptop computer. With new handheld technologies more widely accessible and dropping in price while still gaining additional functionality, a chief security officer and their security staff can now monitor access to their building/doors/control zones, look-up user and card information, trigger queries/reports, set new alarm conditions and monitor sensors from a handheld device anywhere in the world using an electronic communication medium, such as a PDA, cell phone, radio, or the like. In addition, location-based point in time information specific to the handheld device and user can be an input into the authentication module/risk algorithm.

This un-tethered capability expands the command, control and surveillance to anywhere and anytime, yet can be restricted to authenticated, authorized users. For devices with smartcard and/or biometric capabilities, one aspect of the invention also enables an authorized handheld/mobile device user to enroll any individual into the converged security system, write any confirmations or identifiers back through to the device or token, and grant access privileges based thereon. Security controls maintained at the server/network layers can also be pushed/pulled to each device as needed.

One exemplary aspect ensures security of the endpoint device in that the services and the entire network of devices and services can be hardened. For example, one exemplary aspect utilizes GUIDs (Global Unique Indentifies), encompassing hardware, firmware, operating systems and application software devices, as well as the communication medium and transmission layers. The GUIDs corresponding to the identity of the users and all users interconnected as well as the GUIDs of individual, heterogeneous security devices and services can also be leveraged joining previously disparate platforms and systems, including remote terminal units found in Supervisory Control and Data Acquisition (SCADA) systems, radios, or the like. GUIDs and mechanisms using a Public Key Infrastructure (PKI) and digital certificates or device ID's can be employed in operating system and application software licensing, thus preventing counterfeit, backdoor-laden, and malware from being installed or inserted into the hardware, firmware, and software of intelligent devices. Ensuring the limited, verifiable functionality and integrity of each layer of each element of an endpoint device that authenticates and is granted privileges to the network and mutually authenticating the network devices/infrastructure is critical in countering current and future threats spanning impersonation, cloning, counterfeiting, tampering, and the like, to include issues wherein the handheld units and network devices are infected/tampered prior to the delivery to the end users. Moreover, areas of Read-Only Memory (ROM) and burned-in firmware on devices may be burned or re-burned with an approved agency-specific or corporate-specific system image to counter this threat. This type of trusted ROM adds an extra degree of authentication to the system architecture.

Exemplary functionality associated with one or more mobile devices according to an exemplary aspect of this invention are governed by user role based-security and include:
Monitor events, video and sensors;
Receive notifications of predefined alarms;
Set new alarm conditions;
Query and update user identity and one or more of privileges, permissions, and attributes;
View video cameras and/or feeds and optionally control pan, tilt, and zoom functions of the same as well as optionally record therefrom and/or capture screenshots;
View and modify one or more physical configurations and settings;
View one or more critical infrastructure screens;
Restrict usage to authorized users on authenticated devices;
View and authorize GPS coordinates of users requesting authorization to the converged security system (CRITSEC); and
Enroll a user into a converged security system and grant access privileges.

In accordance with another exemplary aspect, the system allows unprecedented reach using familiar role-based access control principals and enforces policy-based, yet agile, security and event control. The system enables various tiers or levels of trust to be codified and this means that it is useful in daily life and can scale in degree of security rigor when situations or incidents occur. Most existing phones, PDAs, radios, and portable devices spanning radios to wearable devices with a modern mobile operating system can be hardened to utilize the features discussed herein including GUIDs effectively. Newer multi-function devices are now available that include smartcard, certificate-based, and/or biometrical authentication for Transportation Worker Identification Credentials (TWIC), Personal Identity Verification (PIV), First Responder ID, HSPD12, FI PS-201 or any government ID, and Common Access Card (CAC) credential validation, and these can be conjoined along with other future converged and consolidated devices that will be available, i.e., the screen is also a fingerprint sensor, the camera a retina or facial scanner and/or the device can become the identifier. Employing a combination of security policies, roles and certificates to address configurations, access and application execution, an exemplary aspect of the invention allows a converged network and physical security administrator or operator to utilize current converged security systems or existing and future service/network infrastructures, situational awareness suites/dashboards and identity management systems.

Additional exemplary aspects of the invention are directed toward:

Virtual perimeters using mobile devices, including wearable computers, PDAs, handheld devices, smart phones, radios, sub-notebooks, tablets PC's, implants, and the like;

Utilizing un-tethered devices such as a client portal into a converged logical and physical security system;

Utilizing non-traditional communication backends or mediums including cellular voice and satellite voice services to extend the visibility control over a converged IT/physical event;

Utilizing non-traditional communication backends or mediums including cellular voice and satellite voice services to extend the visibility control over a physical security events and/or IT/network security event;

Utilizing non-traditional communication backends or mediums such as Wi-Max—microwave communications medium, or in general, any wireless and/or satellite communication protocol(s) for management control;

Leveraging device specific functions, i.e., GPS/cell phone/satellite triangulation and a handheld can add a fourth factor of authentication/identity privilege-granting criteria, wherein the device's physical location is another input into the authentication risk algorithm/neural network;

Time-based criteria also adds input to the risk algorithm for determining authentication method and levels as well as other factors including rate of speed of travel and navigation routes, whether the user is within a perimeter, etc., can be inputs to the risk manager module;

Viewing and interacting with systems (as an authenticated and authorized administrator) via the disclosed architecture is extended by the ability to control IT security defensive/offensive layers, physical security devices, and other physical, computer-control devices as well as converged security systems; and

Limiting access to authorized physical devices or identities.

Expanding this is the ability to utilize components of devices required for authentication, e.g., SIM chip, hardware security module, custom or burned ROM, and the like, in a “sandbox,” or virtual machine type of environment. This expansion provides an authorized user with the ability to still connect securely using another device, perhaps a personally-owned unit or a unit from inventory not yet authorized although policy may allow a different degree of privilege when connected through a non-authorized device as appropriate to the risk. To further enhance security a ROM can be created and made trusted by making the ROM government, agency or corporate specific, optionally with encryption.

Authenticated users can be allowed to utilize the services, and the roles will define the degree of authentication (1—what you know, i.e., pass phrase/pin, 2—what you have, e.g., a token and/or the mobile device itself or a combination of the features of the device, 3—who are you, i.e., a biometric, and 4—an arbitrary factor, such as time and location), as well as privileges. All authentication levels/mechanisms and privileges can be modified based upon, for example, threat levels, policies, rules, implementation environment, and the like. The privileges and authentication required for certain functions can be different than when the user is logged onto a smart device, work station, secure terminal at the office, or the like.

Multiple users may be defined for each device or a plurality of devices, each with specific authentication specifications and privileges when using a shared device.

Authorized operators may enroll users into the IT/network and physical security management system and/or converged security system and grant and/or revoke privileges as necessary.

The IT/network and physical security management system and/or converged security system user directory systems, HR and identity management systems may be leveraged, i.e., LDAP, active directory, SQL, or the like.

The degree of encryption strength and authentication mechanisms required for specific communications mediums can be defined and automatically detected/adjusted to policy and threat levels.

A unique user and device identifier may include data structures of a CHUID (Card Holder Unique Identifier), UUID (Universal Unique Identifier), or GUID (Global Unique Identifier optionally including a composite GUID).

In accordance with one exemplary embodiment, the ability to access the converged IT/network and physical security platform is implemented in a client-server model where the handheld or mobile device connects to the CRITSEC server/IMPACT with the CRITSEC/IMPACT service/applications executing therein. The connection can be made using standard TCP/IP data connectivity or future protocols so any connection medium can be utilized such as Wi-Fi, 3G/4G/5G, Ethernet, and the like, and the transmission can be dynamically re-routed between medium types to ensure the transmission/dialog is complete. The data communications between the client and server can be encrypted when the TCP/IP socket has been established, preventing man-in-the-middle attacks and data snooping from occurring.

Once connected, a user should be authenticated, except for public-level broadcasts. Without authentication, the server should not allow any privileged commands to be processed. The server can request that the user provide various information for a multi-factor authentication including, but not limited to, user name/password, knowledge-based answers, challenge-response interchanges, biometrics, device ID, location (longitude and latitude), certificates, and the like. If conditions the CRITSEC server are configured to identify and respond to are not met, the CRITSEC server can optionally disconnect the user and not accept any commands therefrom. This can also be logged and an event generated that creates, for example, an alert for a security manager. The level of authentication, meeting the methods which are required based on location, time, threat level and the like, can be established in the server. After authentication, the user will be able to send commands to the CRITSEC server using the mobile device interface.

The software running on the mobile device is capable of sending the same commands that the CRITSEC software is able to send/receive/understand. What commands a user is allowed to issue can be determined by the privilege the user is granted, for example, to a directory service or into trusted enclaves of the CRITSEC server itself. When a command is received by the CRITSEC server, and if the user has already successfully authenticated and has privileges to the requested action, the server/application takes the appropriate actions to execute the request and returns the results, if one is needed, to the user. These results can include, for example, user data, confirmation of password reset, closing of the mobile connection, or any of the results typical to the management, use, and administration of the CRITSEC architecture and network of systems.

The software on the mobile devices can be installed like most mobile software with a setup installer. An optional configuration module could require that in order to authenticate on the CRITSEC server, a specific mobile device is required, and only commands from that specific devices/users running the mobile software will be accepted. To restrict access to only particular device, an access list could be created within the CRITSEC environment using a unique identifier, for example, the device ID, MAC address, GUID/composite GUID or the like, of each device that is to be allowed/authorized. The identifier could optionally be retrieved from attributes of the mobile device, and once the identifier is integrated into the list, only those devices on the list would be able to connect.

The software on the mobile devices is also able to communicate and authenticate to the active directory or LDAP directory type services through different methods, including ODBC and future protocols. For example, if the mobile device supports LDAP/active directory (or in general any database structure), and the device is able to connect to a CRITSEC server with a LDAP service running (such as active directory) and since there is no firewall or the firewall allows for remote LDAP/active directory connections, then the software on the mobile device can connect and issue direct LDAP/active directory commands to control the data for the LDAP/active directory service. If the device does not support LDAP/active directory, or by policy the access to open ports is controller/limited, the software on the mobile device can utilize the same connection socket that is used for regular communication to send commands to the CRITSEC server, and commensurately, the CRITSEC server could then issue the command or return the data requested by the command.

To authenticate to the CRITSEC server in accordance with one exemplary embodiment, the software on the mobile device can send the authentication command to the CRITSEC server along with the user name/password and any other needed data for authentication. The CRITSEC server will then take the data and do the actual authentication through LDAP/active directory and then return the result back to the mobile client through the socket connection. All commands involving LDAP/active directory require the user issuing the command authentication information which is then used by the CRITSEC server to try and run the appropriate LDAP/active directory command so that the existing authorization information is used. This prevents, for example, unauthorized usage by non-privileged users because it is using the existing LDAP or active directory level permissions.

Exemplary functionality controllable by the mobile device also includes (in a step-by-step fashion):

Receive notifications and predefined alarms
1. An event occurs (such as a card read or change at an input device).
2. CRITSEC server logs the event and checks in the settings if the event matches a rule or threshold that was defined, derived or configured for alerting.
3. If the event matches a rule set or a set of conditions, the CRITSEC server will send an alert via all the defined methods (i.e. Email, text message, screen alerts, etc.) and cascading call tree taxonomies can be invoked at time intervals based upon event/response time, etc.
4. Screen alerts are a direct CRITSEC client-server connection, and thus if this is one of the defined rules, the CRITSEC server will send the message to all client's applications (CRITSEC application and Mobile-IMPACT users) which accepts the provided data and highlights and/or displays it instantly to the user allowing them to jump to a particular part of the application (such as the user's card information).

Set New Alarm Conditions
1. User navigates to the event type in Mobile-IMPACT and selects a button to modify the alert settings for this event type.
2. The current settings for this event are loaded by contacting the CRITSEC server for the settings.
3. The user can then enable or disable the methods (i.e. email, text message, screen alerts, etc.) that they want to be alerted with.
4. If the user selects the save button, a command is sent to the server telling it to update the saved settings with the new provided data.

Only Authorized Users on Authenticated Devices May Connect
1. When the application is started, before the user can navigate anywhere, the user must provide authentication details the server requires (username/password, biometrics, etc.).
2. When the user sends the authentication information to the server, another piece called the Device ID is sent with the data.
3. The CRITSEC server receives this data, checks to see if the Device ID that was sent by the device is allowed (if the server is configured to check for this), and then forwards the other authentication pieces to appropriate location (Active Directory/LDAP server, biometric checker, etc.).
4. If the user is successfully authenticated (all configured checks pass) then the server marks this connection and user as allowed to send commands and returns a success result to Mobile-IMPACT application and the user can then begin navigating through the application. Otherwise a failure message is sent to the application and the connection is closed forcing the user to try again.

View and Modify Physical Configurations and Settings
1. Mobile-IMPACT application sends command to CRITSEC server requesting the data for a particular section or device.
2. CRITSEC server checks to see if user is authorized to view data, and if they are, returns the current configuration for that section or device to the Mobile-IMPACT application, which then displays the data to user.
3. If user makes any changes and chooses to save/update, Mobile-IMPACT then sends a command with the updated data to the CRITSEC server.
4. The CRITSEC server then checks to see if the user is authorized to make changes to the settings sent and if the user is allowed, updates the settings for that section or device.

Query and Update User Identity and Privilege Information—this can be accomplished in a similar manner to the “View and Modify Physical Configurations and Settings”.

View and Authorize GPS Coordinates and/or with time information of the User Requesting Authorization to Converged Security System
1. If the server is configured to require GPS location information for authentication, the server will inform the application during the authentication stage and the application will send the phone's current GPS position to the server when it sends the rest of the authentication information.
2. When the server is checking the authentication pieces, the server will check to see if the phone's GPS coordinates/time are within a certain range which is defined by the Administrators.
3. If the data is not in the authorized areas, then a deny access will be issued.

Aspects of the invention relate to security management.

Even further aspects of the invention relate to mobile and/or radio based security management.

Additional aspects of the invention relate to mobile security management of a converged physical and logical security system.

Additional aspects of the invention relate to a mobile device configured with an interface to allow remote feature control of a converged physical and logical security system.

Aspects of the invention also relate to providing an extension of the CRITSEC functionality to one or more mobile devices to includes one or more of alerts, video feeds, pan/tilt/zoom control, log information, controller configuration, user configuration, group configuration, policy configuration, as well as a log in.

Even further aspects of the invention relate to an interface on a mobile device that provides multiple tiers of authentication log in from the mobile device to a converged logical and physical security system.

Aspects of the invention also relate to the use of a mobile device with an interface and/or API that allows one or more of management, control, access to and commanding a converged logical and physical security management system(s) and/or a mobile perimeter.

Even further aspects of the invention relate to providing a mechanism and architecture for physical access control commands to be received by a converged logical and physical security management system.

Even further aspects of the invention relate to a mobile device's ability to issue logical access control commands to a converged logical and physical security system.

Additional aspects of the invention also relate to a mobile device's ability to issue CRITSEC specific commands such as modifying access lists, alert settings, and in general any command for the CRITSEC system.

Even further aspects of the invention relate to an interface on a mobile device that allows the above functionality.

These and other features and advantages of this invention are described in, or are apparent from, the following detail description of the exemplary embodiments.

### BRIEF DESCRIPTION OF THE DRAWINGS

The exemplary embodiments of the invention will be described in detail, with reference to the following figures, wherein:

FIG. 1 illustrates an exemplary security system according to this invention;

FIG. 2 illustrates in greater detail the relationship between the mobile client, business logic and data according to this invention;

FIG. 3 is a hybrid flowchart and system architecture diagram that shows data flow according to an exemplary embodiment of this invention;

FIG. 4 illustrates an exemplary method of exchanging commands between a mobile device and the CRITSEC server(s) according to this invention;

FIGS. 5-17 illustrate exemplary screen captures of a user interface on the mobile device running Mobile-IMPACT according to an exemplary embodiment of this invention;

FIG. 18 is a flowchart outlining an exemplary method for the mobile management of the converged logical and physical security system according to this invention;

FIG. 19 illustrates an exemplary method for generating an alert on the mobile device according to this invention; and

FIG. 20 illustrates another exemplary alert method according to this invention.

### DETAILED DESCRIPTION

The exemplary embodiments of this invention will be described in relation to communications systems and security systems. However, it should be appreciated, that in general, the systems and methods of this invention will work equally well in other types of communications environments, networks and/or protocols and with various logical and physical security systems.

The exemplary systems and methods of this invention will also be described in relation to wired and/or wireless communications devices, such as mobile devices, PDA's, cellular phones, radios, Blackberry®, mobile computers, laptops, tablet PC's, and the like. However, to avoid unnecessarily obscuring the present invention, the following description omits well-known structures and devices that may be shown in block diagram form or are otherwise summarized or known.

For purposes of explanation, numerous details are set forth in order to provide a thorough understanding of the present invention. It should be appreciated however that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured, and/or encrypted system. One or more of the various components/modules could also be converged into one or more of the other illustrated components/modules, such as the smart card reader/writer and/or biometric reader included in the mobile device.

Thus, it should be appreciated that the components/modules of the system can be combined into one or more devices, such as a security system, mobile device, radio, incident management perimeter access control and tracking system, CRITSEC system and the like. As will be appreciated from the following description, and for reasons of computations efficiency, the components of the systems can be arranged at any location within a distributed network without affecting the operation thereof. One or more functional portions of this system could also, for example, be distributed between a mobile device and an associated CRITSEC system.

Furthermore, it should be appreciated that the various links, including the communications channels connecting the elements can be wired or wireless links or any combination thereof, or any other known or later developed element(s) capable of supplying and/or communicating data to and from the connected elements. The term module as used herein can refer to any known or later developed hardware, software, firmware, or combination thereof, that is capable of performing the functionality associated with that element. The terms determine, calculate, and compute, and variations thereof, as used herein are used interchangeably and include any type of methodology, process, technique, mathematical operation or protocol.

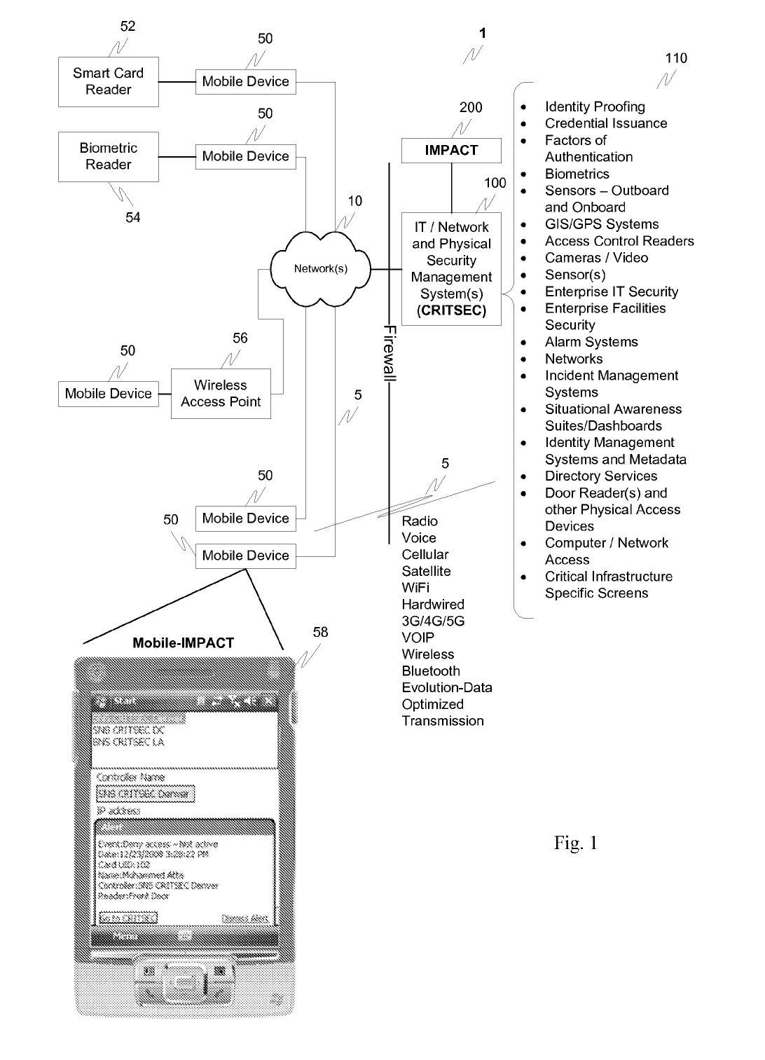

FIG. 1 illustrates an exemplary security system 1 according to this invention. The security system 1 includes an IT/network and physical security management system (CRITSEC) 100, an incident management perimeter access control and tracking system (IMPACT) 100, and one or more mobile devices 50 interconnected by one or more networks 10 and links 5. The mobile devices 50 can also be connected to or include one or more of a smart card reader 52, a biometric reader 54, and can optionally access the network 10 via, for example, a wireless access point 56. Each of the mobile devices 50 are capable of running a Mobile-IMPACT application for which an exemplary interface can be seen on the screen of mobile device 58. As discussed in the related application, CRITSEC 100 can manage one or more of identity proofing, credential issuance, factors of authentication, biometrics, sensors, both onboard and outboard, GIS/GPS systems, access control readers, cameras/video, sensors, enterprise IT security, enterprise facility security, alarm systems, networks, incident management systems, situational awareness suites/dashboards, identity management systems and metadata, directory services, door readers, time and other physical access devices, computer/network access, and the like 110.

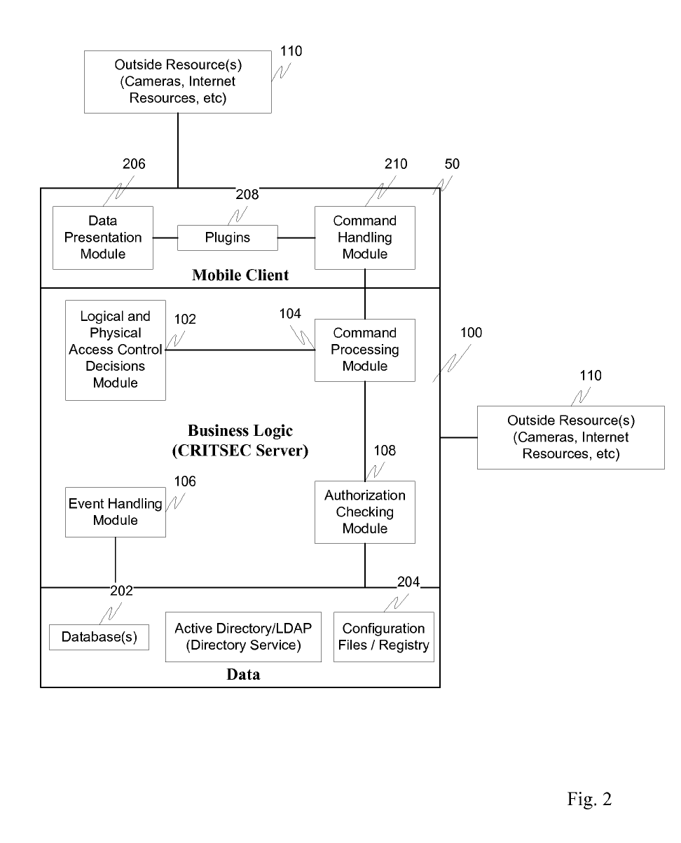

As illustrated in FIG. 2, the mobile devices 50, or mobile clients, can include a data presentation module, one or more plug-ins 208 and a command handling module 210 which are connected to the CRITSEC 100 that can include, for example, a logical and physical access control decisions module 102, a command processing module 104, an authorization checking module 108, and an event handling module 106. These systems can have access to one or more databases 202 as well as configuration files/registry information 204. As illustrated, these systems have access also to outside resources 110, such as cameras, internet resources, and the like as described above. While not illustrated, each system can also include one or more processors, controllers, memory and storage as appropriate.

In operation, the mobile devices 50 are provided with the ability to manage any aspect of CRITSEC 100 or IMPACT 200 remotely. This can have significant advantages, some of which are discussed above in the summary of the invention.

For example, a user with a mobile device 50, provided they have communications connectivity, can one or more of: configure users or user settings in CRITSEC 100, configure or manage the controller in the CRITSEC 100, view, edit and/or export logs as well as view one or more of cameras and sensors as well as control the same via, for example, pan/tilt/zoom controls.

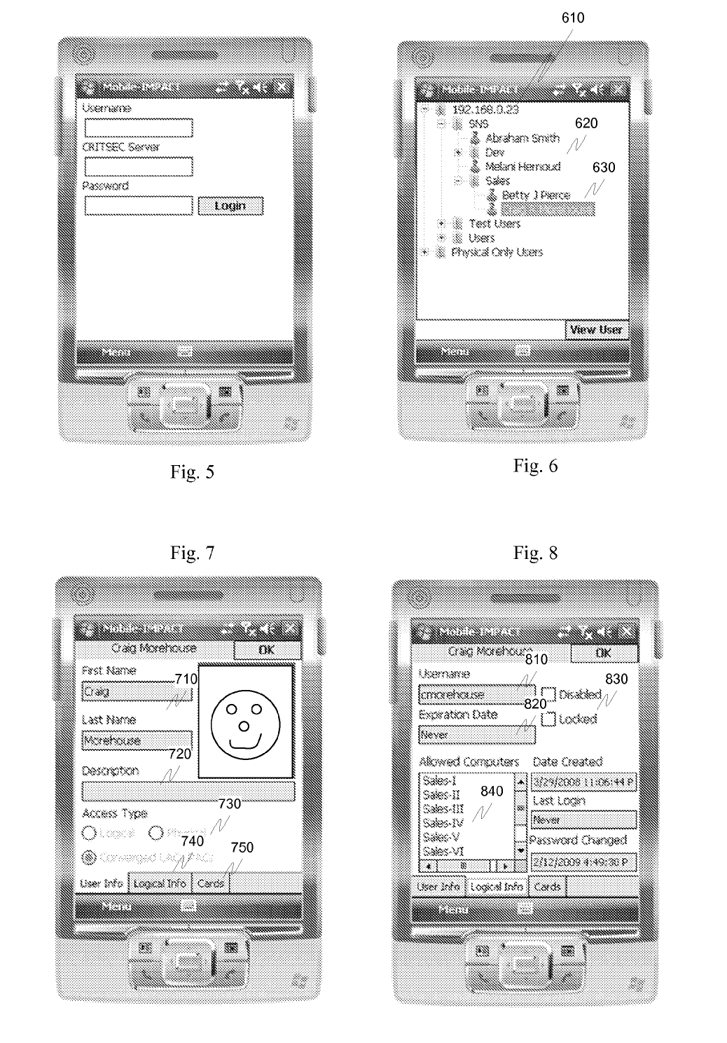

More specifically, and in accordance with an exemplary embodiment, an API runs on the mobile device 50 that provides an interface, such as that shown in 58 as well as FIGS. 5-17. A user, after logging in and being authenticated to CRITSEC 100, can access one or more of the above functions via an associated interface for CRITSEC management. For example, if the user and mobile device 50 would like to view or configure a user or user settings, in cooperation with the command handling module 210, plugins 208, and the data presentation module 206, a list of users can be provided on the mobile device 50. From this list, a user can select to manage or view a particular user, display user information, and optionally display logical access information associated with the user, optionally display card information including card details and access groups associated with the user, as well as perform editing, deleting, or other management of any of the above portions of information. This can all be done, as described hereinafter, through the use of the Mobile-IMPACT interface 58 running on the mobile device 50.

In a similar manner, the mobile device 50 provides access to controller configuration within CRITSEC 100. In general, a user via the mobile device 50 can elect to select and connect to a specific controller. Controller information can then be displayed and the user provided with the ability to view door/reader groups as well as the ability to edit the door/group information or in general any controller functionality.

Log information in CRITSEC and/or impact 200 can also be accessed via the mobile device 50 with the Mobile-IMPACT interface 58, again with the cooperation of the command handling module 210, plugins 208 and data presentation module 206 to one or more of open the logs, view the logs, change display characteristics or sort order of the logs, as well as the option to export the logs, such as to an e-mail, printer, other device, or the like.

The Mobile-IMPACT interface 58 also gives the user of mobile device 50 the ability to access one or more cameras and/or sensors associated with CRITSEC 100. If the camera is provided with controls, the user can also access these, such as pan, tilt, zoom, as well as view the feeds therefrom.

As will be discussed hereinafter, it is to be appreciated that various rules and policies can be associated with any of the above activities based on, for example, a user profile, whether or not the mobile device 50 has been authenticated to CRITSEC 100, and in general any security measures put in place to ensure the user mobile device 50 is actually authorized to manage CRITSEC 100 and/or impact 200.

Due to the lack of LDAP and active directory support in most handheld devices, such as phones, radios, PDAs, and the like, and the optional requirement of keeping the TCP port requirement low for mobile devices 50, an exemplary embodiment of this invention utilizes a set of commands that the mobile application running on the mobile device 50 can use to retrieve and manage data that would otherwise be impossible to retrieve. In accordance with an exemplary embodiment, these commands comprise an identifier of the command, e.g., name or number, so the CRITSEC 100 is aware of what the client is trying to perform, and one or more parameters needed by CRITSEC 100 to execute the command.

For example, to reset a user's password, instead of connecting via LDAP/active directory or another directory service and issuing the required command from the mobile device 50 which would require additional ports to be opened and require the mobile device 50 to support LDAP/active directory protocol or have the protocol ported to the particular device, the mobile device 50 could send a special command that would be understood by CRITSEC 100, with this command including an identifier, for example, any value, and parameters including, for example, the command issuer's user name, command issuer's password, which could be used optionally for authorization, the user's whose password is to be changed, and the password that will be set.

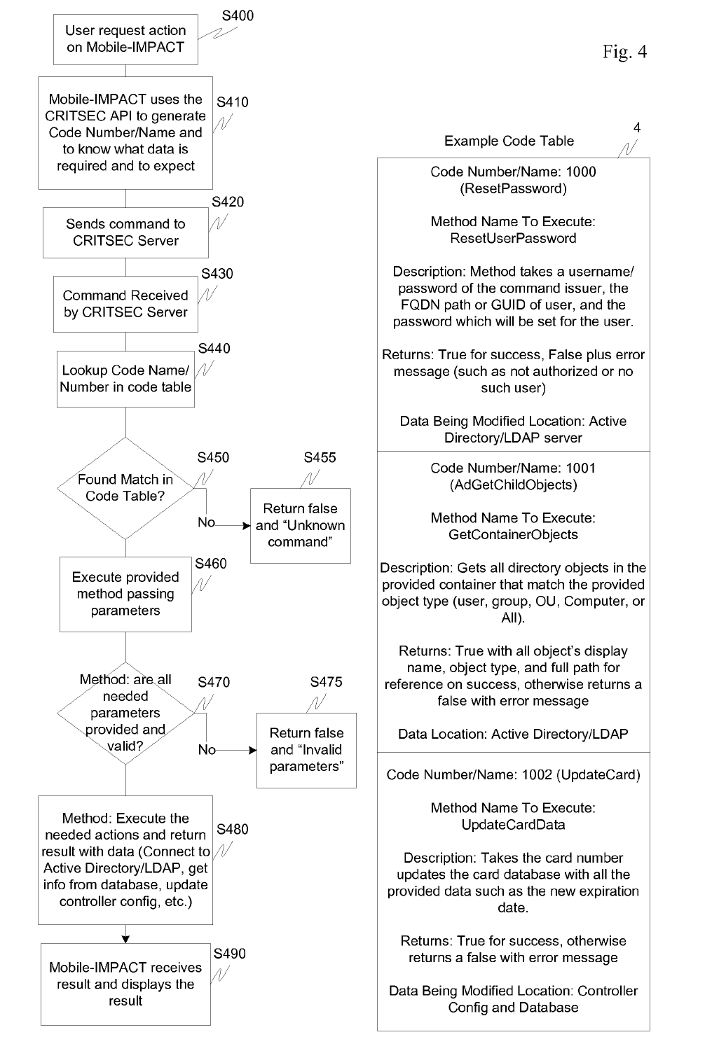

CRITSEC 100 could then make the modification to its active directory or other directory service with CRITSEC 100 understanding the command nomenclature used by the mobile device 50. As will be discussed hereinafter, this command management will be discussed in greater detail in relation to FIG. 4, which is directed toward the exemplary functionality of the command handling module 210 and command processing module 104.

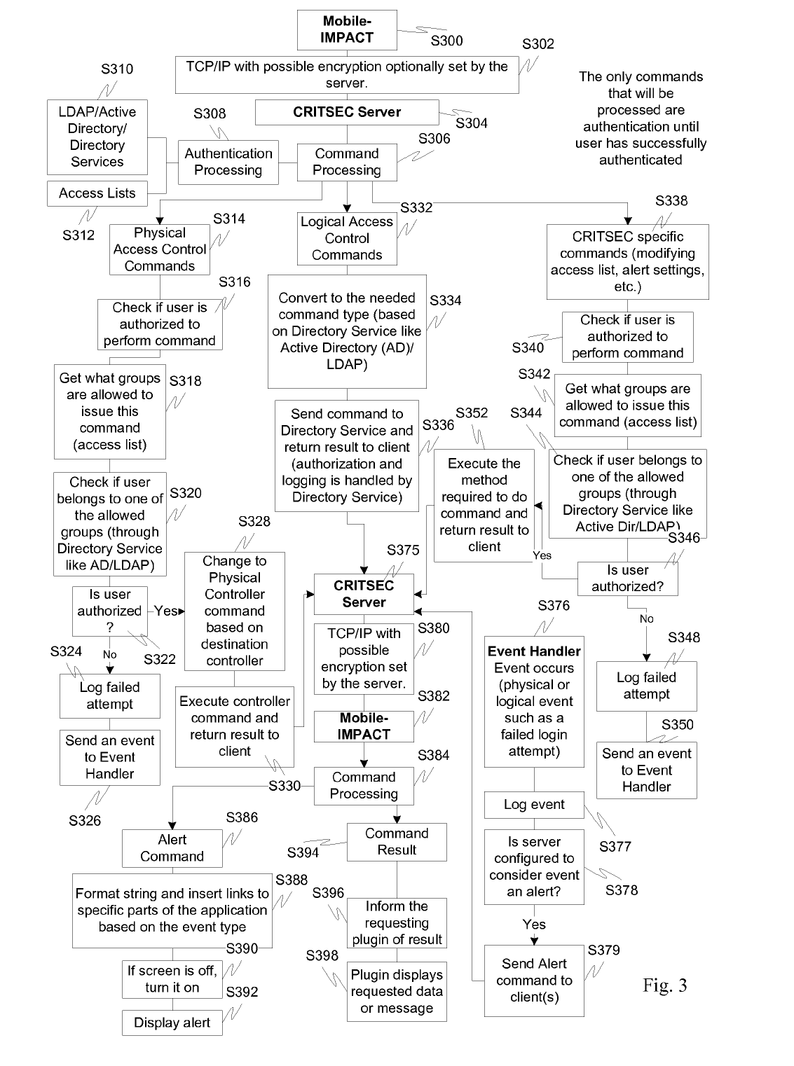

FIG. 3 illustrates an exemplary data flow of the security system 1. In particular, a command is sent from the mobile device in step S300 to the CRITSEC server in step S304. This is accomplished in cooperation with one or more of the command handling module 210, plugins 208 and data presentation module 206. Furthermore, this communication can be done in accordance with TCP/IP protocols with possible encryption optionally set by CRITSEC 100.

Upon receipt of the command in the CRITSEC server 304, and in cooperation with the command processing module, logical and physical access control decisions module 102 and authorization checking module 108, command processing is performed in step S306, with the first command being processed being authentication. More specifically, authentication processing is performed in step S308, with the cooperation of the LDAP/active directory/directory services S310 and access lists S312. As can be appreciated, the security system 1 can optionally be configured such that the only commands that will be initially processed until authentication has been completed are authentication request commands. Once authentication is complete, the mobile device 50 can send one or more of physical access control commands in step S314, logical access control commands in step S322, and CRITSEC specific commands in step S338.

More specifically, if the mobile device 50 sends physical access control commands in step S314, an optional check can be performed in step S316 to ensure the user and/or the mobile device 50 is authorized to perform that command. For example, in step S318, the groups that are allowed to issue the command in question are retrieved. Then, in step S320, a check is made to determine whether the user/mobile device belongs to one of the allowed groups through, for example, a directory service like LDAP/active directory. A determination is then made in step S322 whether the user is authorized to perform the command. If the user/mobile device is authorized to perform the command, control continues to step S328 with control otherwise jumping to step S324. In step S324, the failed attempt to execute the command can be logged and, in step S326, an optional event sent to the event handling module 106.

In step S328, and in cooperation with the command processing module 104, the physical controller command can optionally be changed based on the destination controller the command is intended for. Then, in step S330, the command can be executed and, if necessary, a result returned to the client at mobile device 50. Control then continues to step S375 where control returns to the CRITSEC server.

In step S322, a user has sent a command for logical access control. Next, in step S334, and in cooperation with the command processing module 104, the command can optionally be converted as needed, for example, based on a directory service like active directory/LDAP. Then, in step S336, the command can be sent to the directory service and result returned to the client, if required. In this illustrative example, the authorization and logging can be handled by the directory service with control continuing to the CRITSEC server in step S375.

In step S338, a user has issued a CRITSEC specific command from the mobile device 50. In step S340, an optional check can be performed to ensure the user is authorized to perform the command. Next, in step S342, the groups that are allowed to issue the command are retrieved and in step S344, a check to determine whether the user requesting the command belongs to one of the allowed groups. Similar to the above embodiment, this can be performed through a directory service like LDAP/active directory. In step S346, a determination is made whether the user is authorized. If the user is authorized, control jumps to step S352 with control otherwise continuing to step S348. In step S348, the failed command attempt can optionally be logged within step S350 and an event, with cooperation of the event handling module 106 sent to the event handler.

In step S352, a command is executed and any necessary results returned to the client with control continuing to step S375.

In step S380, communication, such as TCP/IP with possible encryption is established with Mobile-IMPACT 382. Then, in step S384, and optionally in cooperation with the command handling module 210, mobile device 50 performs command processing based on commands/data/other information from the CRITSEC server in step S375. For example, in step S386, an alert command has been sent to the mobile device 50 which, when read by the command handling module 210, and in cooperation with one or more of the plugins 208 and the data presentation module 206, can generate an appropriate interface corresponding to the alert then, for example, in step S388 format a string and insert one or more links to specific parts of the application based on the event type.

For example, if the alert has to do with a user trying multiple times to gain access through a door, and those access attempts having failed and number of attempts reaching a threshold, links can be provided in the alert that allow the user to immediately view a camera feed of that door as well as the log information so the user at the mobile device 50 is aware of what access credentials/factors and associated biometrics the user is attempting to use to gain access to the door. In addition, and optionally in step S390, control of the mobile device 50 can be further manipulated by the alert command, such as turning the screen on, vibrating, playing an audio or visual alert queue, and displaying alert information, as in step S392.

In step S394, one or more of command, data and information have been returned to the mobile device with, in step S396, requesting plugin being informed of the result. As discussed, this result can be data, video feed, sensor information, user information, or in general any information relating to the security system 1. Then, in step S398, the plugin 208, in cooperation with the data presentation module 206, displays the requested data, message, information, or the like.

Event handling occurs with the cooperation of the event handling module 106, and one or more of the other modules as illustrated, for example, in FIG. 2. For example, if an event occurs, e.g. a physical, logical, or other event, such as failed login attempt, in step S377, the event can optionally be logged. Then, in step S378, a determination is made whether the event is significant enough to trigger an alert. It should be appreciated, that a single event could be configured to trigger an alert, multiple events of the same type, or a combination of events when looked at in totality be the trigger for an alert. If an alert is required, in step S379, an alert command is sent to the CRITSEC server S375 which, as previously discussed, can forward the alert to the mobile device 50.

As mentioned earlier, for mobile devices that do not include the ability to perform LDAP or active directory services, an architecture needs to be established that allows communication between the mobile device and the CRITSEC 100. An exemplary method of performing this command exchange and translation is shown in FIG. 4.

More specifically, in step S400, a user requests an action on the mobile device. Next, in step S410, the mobile device uses, for example, a CRITSEC API, to generate a code number/name that corresponds to the requested action and can be formatted such that the appropriate data and/or parameters are included therewith. Then, in step S420, the assembled command is sent to the CRITSEC server. Control then continues to step S430.

In step S430, the command is received by the CRITSEC server. Next, in step S440, the code name/number is looked-up in a code table, such as that illustrated in the example code table 4. Control then continues to step S450.

In step S450, a determination is made whether a match is found in the code table. If a match is not found, in step S455 an unknown command message can optionally be returned to the mobile device. Otherwise, in step S460, the command associated with the action or request is executed and parameters passed. Then, in step S470, a determination is made whether all parameters that are needed to execute the command have been provided and are valid. If the answer to this decision is no, control continues to step S475 where an invalid parameter message can optionally be returned to the mobile device. Otherwise, control continues to step S480 where the command is executed and result returned with data to the mobile device which is then displayed in step S490.

For example, in step S480, the server can connect to the active directory/LDAP, retrieve information from a database, update a controller configuration, update a user or a user configuration, or the like, and one or more of a confirmation, additional information, or the like, as appropriate, return to the mobile device is step S490.

The example code table 4 illustrates various example codes corresponding to exemplary action requests. For example, in example code table 4, code name 1000 is associated with a resetting password action. Code number 1001 is associated with an ad get child objects action. Code number 1002 is associated with an update card action. Associated with each of these code numbers, there is a description of the method name which is executed, a description of the method, what is returned to the mobile device, and a summary of the data being modified and/or data location.

FIGS. 5-17 illustrate exemplary screen captures on a mobile device 50 according to an exemplary embodiment of this invention. In this particular exemplary usage scenario, a user logs in, performs various functionality on the CRITSEC server, receives a video feed, and, in FIG. 17, receives an alert.

More specifically, in FIG. 5, an interface is provided on the mobile device 50 where the user provides the login credentials to login to the CRITSEC 100. These can be the same credentials that the user uses for active directory login and to login to CRITSEC directly. The CRITSEC server field can optionally be provided with the IP address or host name of the CRITSEC the user will be logging into, in the event there is more than one. As discussed above, and as a security feature, one or more portions of the application can be disabled until the user has logged in and been authenticated to prevent someone who is not authorized from being able to access, change, or view secure information.

FIG. 6 illustrates an exemplary configuration area of a CRITSEC located at IP address 610. A list of users 620 is illustrated that belong to the server/domain associated with the IP address 610. In this particular example, user “Craig Morehouse” has been selected, so the user of the mobile device can retrieve and/or edit information associated with that particular user.

In FIG. 7, basic user information associated with user 630 is displayed including the selected user's first and last name 710, as well as the description entered for the user 720. The interface also illustrates the user's access type 730 whether they have rights to enter the facility, log on to the computer system, or both. The user who is logged on to the application may not have the ability to access edit functionality associated with this user, which is why in FIG. 7, the field are grayed out as being “read-only.” If the user viewing this user's data had appropriate permissions, these fields could obviously be editable.

FIG. 8 illustrates an exemplary interface where a user has selected the logical info tab 740 from FIG. 7. In this interface, the details that the user uses to log on onto the computer system are shown. For example, user name 810, expiration date 820, and indication whether the account is disabled or locked 830, as well as a list of allowed computers 840 are shown in the interface. A user with the appropriate permissions could obviously disable the user from being able to log in by selecting the disable button or, for example, unlock their account if the user mistakenly entered their password incorrectly to many times.

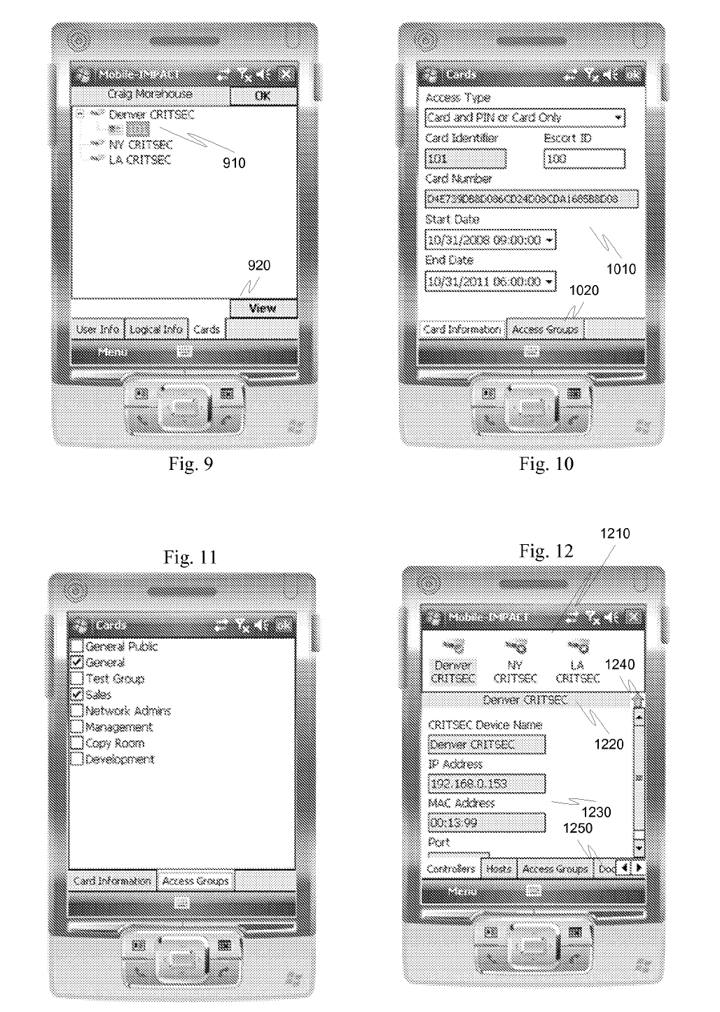

FIG. 9 illustrates an exemplary user interface that can be displayed when the user selects the cards tab 750 from FIG. 7. The cards tab shows the cards that belong to the user Craig Morehouse and in accordance with this exemplary embodiment, it can be seen that the user only has one card 910 and that one card is only granted access to one facility “Denver CRITSEC.” The user of the mobile device can then select the card and click the view button 920 to view/edit information about the card.

More specifically in FIG. 10, additional information associated with the card 910 is shown. In interface 1010, various information such as the access type, card identifier, escort ID, card number, start date, end date, and the like, and in general any information associated with the card, can be displayed. This interface also allows a user to determine what groups this user/card is associated with for physical access, by clicking on the access group tabs 1020.

FIG. 11 illustrates the various groups the user/card is associated with and, as can be seen, this exemplary user is associated with the general and sales groups.

FIGS. 12-14 illustrate exemplary methods for configuring a controller according to this invention. In particular, the interface in FIG. 12 illustrates that the user has moved to the controller configuration area, where the user is looking at the list of controllers available for connection, and has selected Denver CRITSEC 1220. Upon selection of one of the available controllers 1210, information about that controller can be displayed in interface portion 1230 with information such as device name, IP address, MAC address, port information, and the like, shown. This information can be minimized, for example, by clicking on the up arrow 1240.

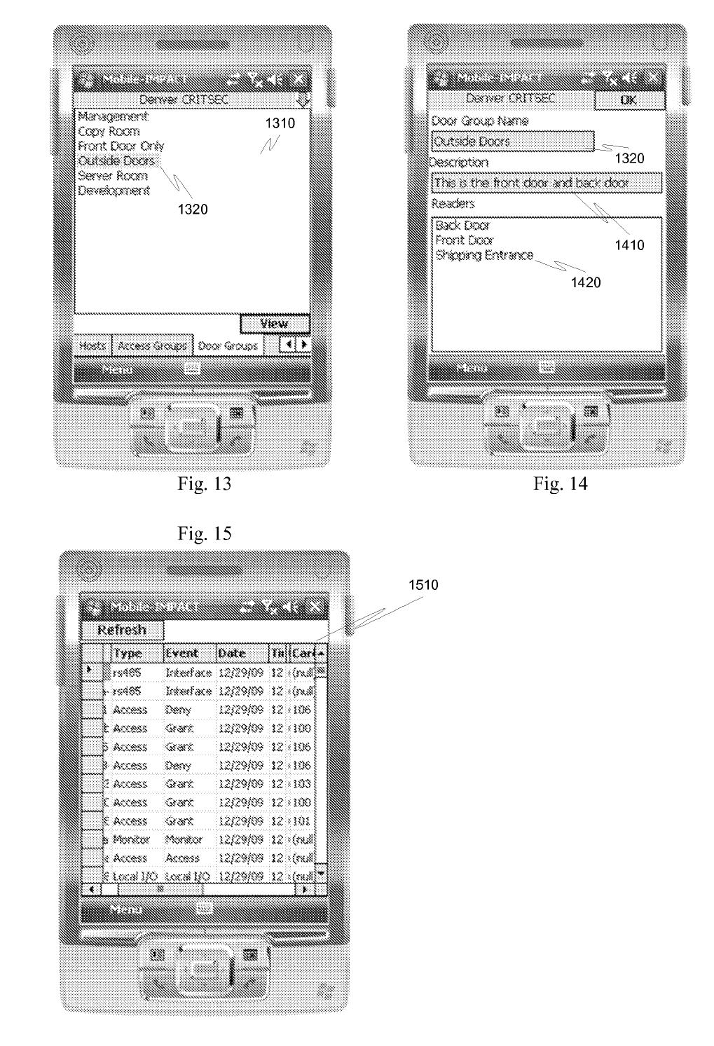

Although partly obscured, when the user selects the door groups tab 1250 in FIG. 12, the exemplary interface in FIG. 13 can be displayed. This interface shows the door groups 1310 that are part of the Denver CRITSEC controller. If a user selects outside doors 1320, information about the outside door group is displayed in interface shown in FIG. 14. From the interface in FIG. 14, it can be seen that the group outside doors 1320, has an associated description 1410 and readers 1420.

FIG. 15 illustrates an exemplary interface associated with log viewing. For example, the interface 1510 includes type information, event information, data and time information, and in general any information associated with one or more events. As previously discussed, this information can be sorted by selecting any of the tabs at the interface 1510 as well as exported, printed, copied into an e-mail, forwarded to another destination, sent to forensics in a tamperproof manner, or the like.

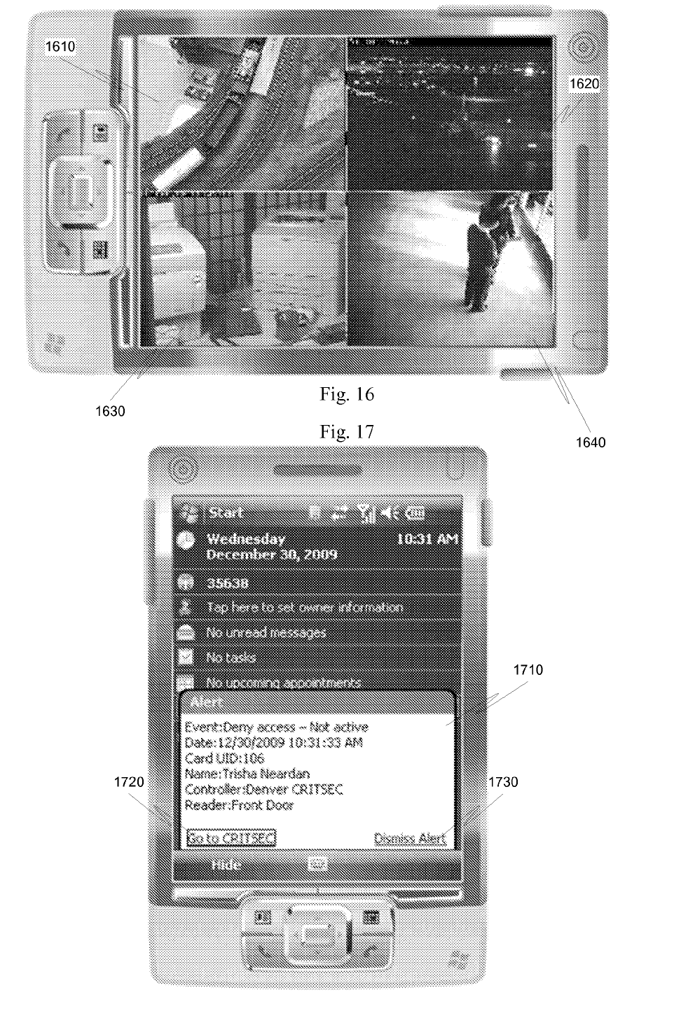

FIG. 16 illustrates an exemplary interface where the user has requested to view four camera feeds 1610-1640. The user can add or subtract any number of feeds from the interface illustrated in FIG. 16, and for certain cameras that may have an ability to be controlled via pan/tilt/zoom controls, these controls can also be populated and selectable by the user via the interface for control of that camera.

The interface in FIG. 17 illustrates an alerting screen that includes information unique to the security system. For example, the Mobile-IMPACT application can run in the background when the user is not using it, and still receive messages, such as instant messages and alerts from the CRITSEC server, for example, when there is an alert. The message can optionally appear and play sound, vibrate, or otherwise notify the user that they have an alert, and this alert can override other applications running on the mobile device. For example, if the screen of the mobile device is turned off, the alert can turn the screen on for the user thereby providing the user with the ability to work on other applications while still being able to monitor their security infrastructure.

In this particular example, there is an alert 1710 illustrated on the interface. The alert includes event information, date information, card information, name information, controller information, as well as the reader information. In addition, relevant links can be provided 1720 and 1730 that allow a user immediate access to management operations that may be associated with the alert. These links 1720 and 1730 can be dynamically created based on the type of the alert, the severity of the alert, type of event, or in general, based on any information associated with the alert.

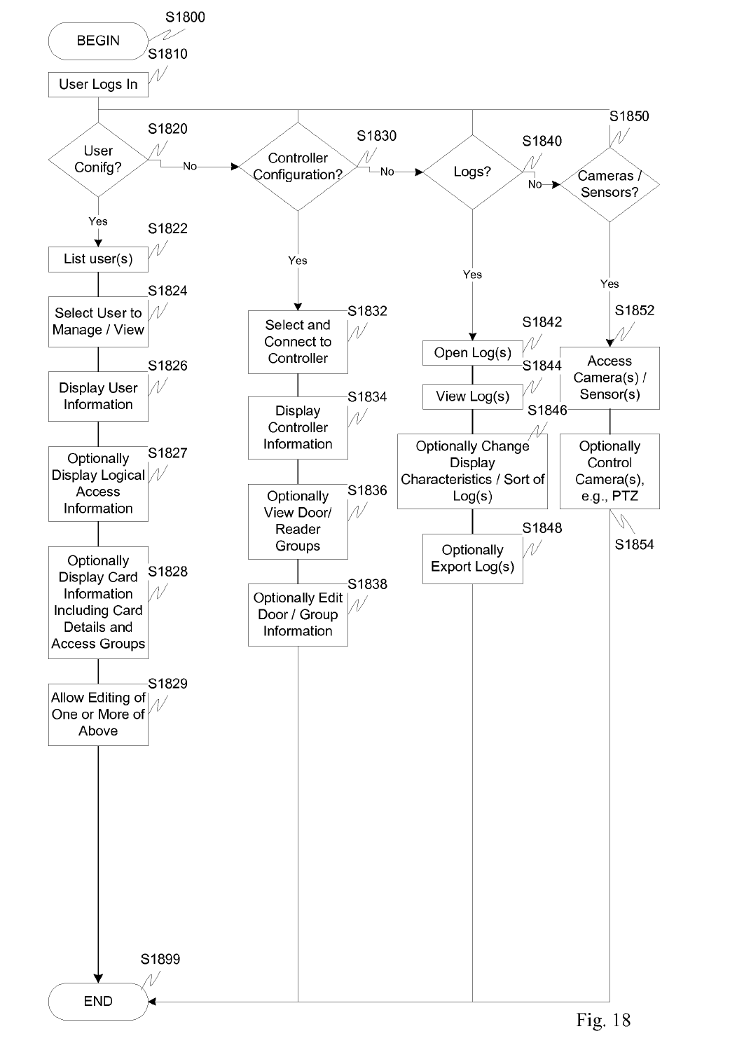

FIG. 18 illustrates an exemplary method of utilizing the Mobile-IMPACT application. In particular, control begins in step S1800 and continues to step S1810. In step S1810, a user logs in. As previously discussed, this could be an initial authentication with, depending on the nature of the requested action, additional authentication, passwords, or the like required. Once a user logs in, a user has the option of configuring and/or viewing user information in step S1820, controller configuration in step S1830, viewing log information in step S1840, and/or accessing cameras/sensors in step S1850. If a determination is made that the user would like to access user information in step S1820, control jumps to step S1822. If the user is requesting controller configuration in step S1830, control jumps to step S1832. If the user is requesting log information, control jumps from step S1840 to step S1842. If the user is requesting camera and/or sensor information in step S1850, control jumps to step S1852.

More specifically, in step S1822, one or more user lists can be provided. Next, in step S1824, a specific user can be selected for management and/or credential viewing. Then, in step S1826, information relating to the user is displayed. Control then continues to step S1827.

In step S1827, logical access information associated with the user can optionally be displayed. In step S1828, card information including card details and access groups can optionally be displayed. In step S1829, a user, provided they are authorized to perform editing, can be allowed to edit one or more of the above pieces of user-specific information. Control then continues to step S1899 where the control sequence ends.

In step S1832, a controller is selected and the mobile device connected thereto. Next, in step S1834, controller information can be displayed, within step S1836 one or more door and reader groups information optionally viewed. Similarly, and again depending on user authorizations, door and/or group information can optionally be edited in step S1838.

In step S1842, one or more logs are opened. Then, in step S1844, the logs can be viewed with the display characteristics thereof changed and/or sorted as provided in step S1846. In step S1838, the user is provided with the option of exporting and/or forwarding the log with control or to forensics continuing to step S1899, where the control sequence ends.

In step S1852, a user has requested access to one or more cameras and/or sensors. Upon access, information relating to the sensors and/or video and/or audio feed associated with one or more cameras can be displayed on the mobile device. Furthermore, in step S1854, an option is provided that allows the user to control pan, tilt, and/or zoom functionality associated with the one or more cameras. In a similar manner, although not illustrated, if the sensors have an associated control, the sensors can also be manipulated by the mobile device.

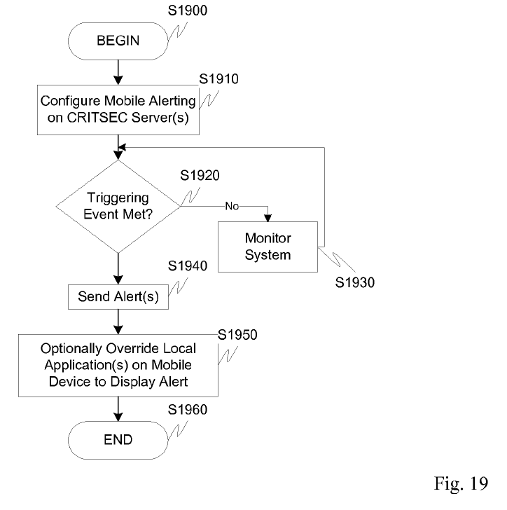

FIG. 19 illustrates an exemplary method of alerting a mobile device according to this invention. In particular, control begins in step S1900 and continues to step S1910. In step S1910, mobile alerting can be configured on the CRITSEC that allows for mobile alerts to be sent to one or more mobile devices. Once this configuration has been established, in step S1920, a determination is made whether a triggering event or combination of events has been satisfied. If a triggering event has not been satisfied, control continues to step S1930 where the system is continually monitored with control jumping back to step S1920. If a triggering event, or combination of events has been met, in step S1940, an alert command is sent to the mobile device(s). Once this command for an alert has been received at the mobile device, the command can optionally override local applications, services, or the like, on the mobile device to display the alert and information associated therewith in step S1950. As previously discussed, this alert can also include dynamic hyperlinks based on the alert that may be relevant to the user based on the nature of the event. Control then continues to step S1960 where the control sequence ends.

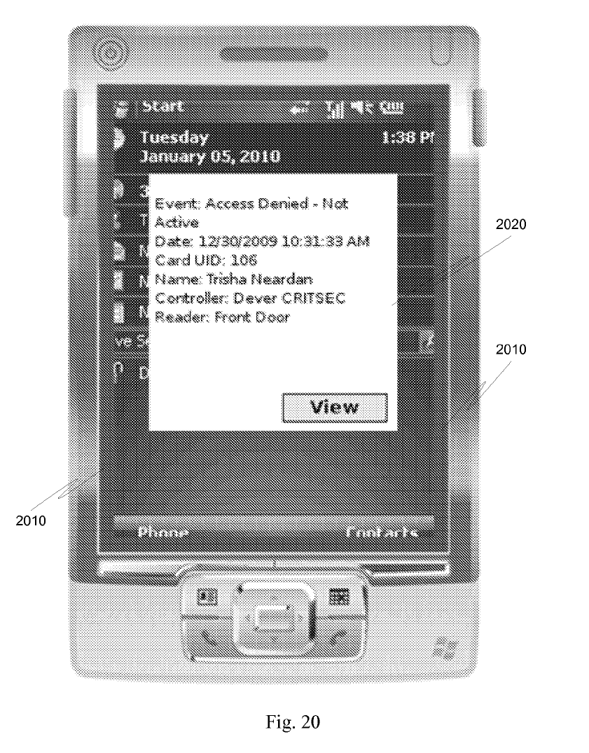

The interface in FIG. 20 illustrates another exemplary alerting screen that includes information unique to the security system. In this particular example, there is a colored (an optionally flashing) alert box 2010 illustrated on the interface. The alert 2020 includes event information, date information, card information, name information, controller information, as well as the reader information.

The above-described methods and systems and can be implemented in a software module, a software and/or hardware module, a security management device or interface, a wired and/or wireless wide/local area network system, a satellite communication system, network-based communication systems, such as an IP, Ethernet or ATM system, ROM, or the like, or on a separate programmed general purpose computer having a communications device or in conjunction with a wired or wireless communications protocol.

Additionally, the systems, methods and protocols of this invention can be implemented on a special purpose computer, a programmed microprocessor or microcontroller and peripheral integrated circuit element(s), an ASIC or other integrated circuit, a digital signal processor, a flashable device, a ROM, secure ROM, a hard-wired electronic or logic circuit such as discrete element circuit, a programmable logic device such as PLD, PLA, FPGA, PAL, any comparable means, or the like. In general, any device capable of implementing a state machine that is in turn capable of implementing the methodology illustrated herein can be used to implement the various methods, protocols and techniques according to this invention. While the systems and means disclosed herein are described in relation to various functions that are performed, it is to be appreciated that the systems and means may not always perform all of the various functions, but are capable of performing one or more of the disclosed functions.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems, methods and protocols illustrated herein can be readily implemented in hardware and/or software using any known or later developed systems or structures, devices and/or software by those of ordinary skill in the applicable art from the functional description provided herein and with a general basic knowledge of the computer and security arts.

Moreover, the disclosed methods may be readily implemented in software that can be stored on a computer-readable storage medium and/or ROM, executed on programmed general-purpose computer with the cooperation of a controller and memory, a special purpose computer, a microprocessor, or the like. In these instances, the systems and methods of this invention can be implemented as program embedded on personal computer such as an applet, API, JAVA® or CGI script, as a resource residing on a server or computer workstation, as a routine embedded in a dedicated communication system or system component, or the like. The system can also be implemented by physically incorporating one or more portions of the system and/or method into a software and/or hardware system, such as the hardware and software systems of mobile device.

While the invention is described in terms of exemplary embodiments, it should be appreciated that individual aspects of the invention could be separately claimed and one or more of the features of the various embodiments can be combined.

While the systems and means disclosed herein are described in relation to various functions that are performed, it is to be appreciated that the systems and means may not always perform all of the various functions, but are capable of performing one or more of the disclosed functions.

While the exemplary embodiments illustrated herein disclose the various components as collocated, it is to be appreciated that the various components of the system can be located at distant portions of a distributed network, such as a telecommunications network and/or the Internet or within a dedicated communications network. Thus, it should be appreciated that the components of the system can be combined into one or more devices or collocated on a particular node of a distributed network, such as a communications network. As will be appreciated from the following description, and for reasons of computational efficiency, the components of the communications network can be arranged at any location within the distributed network without affecting the operation of the system.

It is therefore apparent that there has been provided, in accordance with the present invention, systems and methods security system access and management. While this invention has been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this invention.

What is claimed is:

1. A method of remotely managing a converged physical and logical security system comprising:
assembling, on a mobile device, a command, the command associated with a method to execute on a converged physical and logical security system;
matching the command to a code table;
performing the method at the converged physical and logical security system; and returning one or more of results, data and information to the mobile device.

2. The method of claim 1, further comprising authenticating one or more of the mobile device and a user.

3. The method of claim 1, wherein the command is a physical access control command.

4. The method of claim 1, wherein the command is a logical access control command.

5. (canceled)

6. The method of claim 1, further comprising performing one or more of a time based authentication and location based authentication.

7. (canceled)

8. The method of claim 1, further comprising validating, based on a comparison to one or more allowed groups or privilege classes, that the method can be performed.

9. (canceled)

10. (canceled)

11. The method of claim 1, further comprising forwarding an alert to the mobile device.

12. (canceled)

13. The method of claim 11, wherein the alert includes a command that one or more of effects the operation of the mobile device and disables the mobile device.

14. (canceled)

15. (canceled)

16. The method of claim 13, wherein a command type is based on a lightweight directory access protocol (LDAP), active directory, database or identity services.

17. The method of claim 1, further comprising providing one or more video feeds to the mobile device.

18. The method of claim 1, further comprising providing information from one or more sensors to the mobile device.

19. (canceled)

20. (canceled)

21. (canceled)

22. (canceled)

23. (canceled)

24. (canceled)

25. A converged physical and logical security system with remote management comprising:
a command handling module that assembles, on a mobile device, a command, the command associated with a method to execute on a converged physical and logical security system and matches the command to a code table; and
the converged physical and logical security system performing the method and returning one or more of results, data and information to the mobile device.

26. The system of claim 25, further comprising an authorization checking module that authenticates one or more of the mobile device and a user.

27. The system of claim 25, wherein the command is a physical access control command.

28. The system of claim 25, wherein the command is a logical access control command.

29. (canceled)

30. The system of claim 25, wherein one or more of a time based authentication and location based authentication are performed.

31. (canceled)

32. The system of claim 25, further comprising an authorization checking module that validates, based on a comparison to one or more allowed groups or privilege classes, that the method can be performed.

33. (canceled)

34. (canceled)

35. The system of claim 25, further comprising an event handling module that forwards an alert to the mobile device.

36. (canceled)

37. The system of claim 35, wherein the alert includes a command that one or more of effects the operation of the mobile device and disables the mobile device.

38. (canceled)

39. (canceled)

40. The system of claim 37, wherein a command type is based on a lightweight directory access protocol (LDAP), active directory, database or identity services.

41. The system of claim 25, wherein one or more video feeds are provided to the mobile device.

42. The system of claim 25, wherein information from one or more sensors is provided to the mobile device.

43. (canceled)

44. (canceled)

45. The system of claim 25, wherein the command is associated with one or more of viewing, editing and managing the converged physical and logical security system.

46. (canceled)

47. The system of claim 25, wherein the mobile device includes one or more of a fingerprint scanner, smart card scanner, retina scanner and facial recognition.

48. (canceled)

49. The system of claim 25, wherein the mobile device is an identifier for the system.

50. (canceled)

51. (canceled)

52. The system of claim 25, wherein the mobile device includes a trusted ROM.

53. (canceled)

54. (canceled)

55. (canceled)

56. (canceled)

57. (canceled)

58. (canceled)
